(19) United States
(12) Patent Application Publication
(10) Pub. No.: US 2019/0018694 A1
(43) Pub. Date: Jan. 17, 2019

(54) VIRTUAL LABORATORY ASSISTANT PLATFORM

(71) Applicant: HelixAI, Inc., Rome, GA (US)

(72) Inventors: James Rhodes, Mount Berry, GA (US); DeLacy Rhodes, Mount Berry, GA (US); Josh Eboch, Charleston, SC (US)

(21) Appl. No.: 16/034,346

(22) Filed: Jul. 12, 2018

Related U.S. Application Data
(60) Provisional application No. 62/531,797, filed on Jul. 12, 2017.

(51) Int. Cl. G06F 9/451; G06F 3/16; G10L 15/26; G10L 17/22; G10L 15/18

(52) U.S. Cl. CPC G06F 9/453; G06F 3/167; G10L 15/18; G10L 17/22; G10L 15/26

(57) ABSTRACT

Disclosed herein is a virtual laboratory assistant platform enabled to provide researchers, science educators, industry professionals, and scientists in the clinical, industrial, or laboratory setting access to information and data, a digital footprint of laboratory activities, and insights into laboratory activities based on the digital footprint.

### CROSS REFERENCE TO RELATED APPLICATIONS

This application claims the benefit of priority to U.S. Provisional Patent Application Ser. No. 62/531,797, filed Jul. 12, 2017, which is hereby incorporated herein by reference in its entirety.

### FIELD OF INVENTION

The present disclosure generally relates to an artificially-intelligent virtual assistant, more specifically a voice-activated, virtual assistant for the laboratory sciences.

### BACKGROUND OF THE INVENTION

When conducting research in a scientific laboratory, researchers often need to access various information such as recipes, protocols, reference data (ex., molecular weight, boiling points, melting points, etc.), inventory, and other information while executing complex movements and tasks. Accessing this information through current systems and methods normally requires researchers to interrupt their work to physically interact with these systems. These interruptions have the potential to introduce inefficiencies, human error, and the potential for inaccurate results as well as a number of other concerns.

Accordingly, there remains a need for new methods and systems for accessing information in the laboratory setting. This need and other needs are satisfied by the various aspects of the present disclosure.

### SUMMARY OF THE INVENTION

In accordance with the purposes of the invention, as embodied and broadly described herein, the invention, in one aspect, relates to a method of providing virtual assistance to a user for performing an activity, such as a laboratory activity. In one aspect, the invention relates to a method comprising: enabling, by a system having at least one processor, a conversation user interface associated with a conversational agent configured as a virtual assistant; receiving, by the system, input data from a laboratory user associated with a laboratory user group, the input data comprising at least one of verbal data, voice data and textual data; determining, by the system, an intent of the laboratory user based at least on the input data and a first context; determining, by the system, a response to the input data based at least in part on laboratory record data associated with the laboratory user group and a second context that is different than the first context; and providing, by the system, the response through the conversation user interface as a message from the virtual assistant.

In another aspect, the invention relates to a method comprising: enabling, by a system having at least one processor, a conversation user interface associated with a conversational agent configured as a virtual assistant; receiving, by the system, speech input from a user associated with a user group, the user having a user profile; processing, by the system, the speech input; determining, by the system, based on the processed speech input that the user requests a technique to perform a laboratory experiment; determining, by the system, a laboratory protocol having one or more steps for the user based at least on the laboratory experiment; and providing, by the system, directions from the virtual assistant to the user for performing the laboratory protocol.

In another aspect, the invention relates to a method comprising: enabling, by a system having at least one processor, a conversation user interface associated with a conversational agent configured as a virtual assistant; receiving, by the system, user input through the conversation user interface, the user input comprising a query from the user about a scientific question; and providing, by the system, a response to the query using the virtual assistant, the response comprising comparative information about factors related to the scientific question for default parameters or typical conditions.

In another aspect, the invention relates to a system comprising a memory storage and a processing unit coupled to the memory storage, wherein the processing unit is operative to perform the disclosed methods.

In another aspect, the invention relates to a computer-readable medium comprising a set of instructions which, when executed, perform the disclosed methods.

This brief overview is not intended to identify key features or essential features of the claimed subject matter. Nor is this brief overview intended to be used to limit the claimed subject matter's scope. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various aspects and embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with an exemplary embodiment of the present invention.

FIG. 2 is a flow chart of a method for providing a virtual laboratory assistant platform according to an exemplary embodiment of the present invention.

FIG. 3 is a block diagram of a system including a computing device for performing a disclosed method according to an exemplary embodiment of the present invention.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited. As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of activities, embodiments of the present disclosure are not limited to use only in this context.

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” includes “at least one” and plural referents unless the context clearly dictates otherwise. Thus, for example, reference to “a user” includes two or more users. When used herein to join a list of items, “or” denotes “at least one of the items,” but does not exclude a plurality of items of the list. Finally, when used herein to join a list of items, “and” denotes “all of the items of the list.”

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of a scientific laboratory, embodiments of the present disclosure are not limited to use only in this context. For example, embodiments of the present disclosure may be used to provide relevant information about a composition or properties about a compound. Further, embodiments of the present disclosure may be used, for example, to teach users how to perform a lab technique or use a lab instrument, provide an augmented interface that may be used in conjunction with instructional videos and the like.

### A. Platform Overview

In accordance with various aspects of the present disclosure, a virtual laboratory assistant platform may be provided. This overview is provided to introduce a selection of concepts in a simplified form that are further described below. This overview is not intended to identify key features or essential features of the claimed subject matter. Nor is this overview intended to be used to limit the claimed subject matter's scope. The virtual laboratory assistant platform can provide researchers, educators, industry professionals, and scientists in the clinical, industrial, or laboratory setting hands-free access to information and data via an artificially intelligent, voice-activated virtual laboratory assistant. For example, the platform may receive user voice instructions or commands requesting various information such as recipes for solutions, multi-step protocols, physical reference data (ex. molecular weight, boiling points, melting points), inventory data and other information and the platform may then retrieve the requested information from a known database and provide the requested information to the user in the form of an auditory response via a voice-activated capable device, for example, the user's mobile phone or a “smart speaker”, such as the Amazon Echo. In some aspects, a user may make requests using natural language, and the platform may compare and match the request to a database of known intents prior to providing the requested information. In further aspects, the platform may use custom logic, routines, and/or data structures to retrieve the requested information before and relay this to the user. In various aspects, the platform may be utilized by users to perform various actions, including, but not limited to: retrieve and relay a list of ingredients to a solution; retrieve and relay steps to a multi-step protocol; retrieve and relay laboratory product and inventory information; retrieve and relay location based information for laboratory supplies and reagents; provide time-dependent reminders for scientific processes; interface with laboratory equipment; interface with inventory and laboratory management systems (LIMS); interface with Electronic Laboratory Notebooks (ELN); purchase laboratory equipment and reagents; perform mathematical calculations and relay results; retrieve and relay physical properties and/or reference data for enzymes, chemicals, and chemical compounds, and the like; retrieve and relay scientific abstracts and journal articles; retrieve and relay scientific textbooks; record and store experimental data, data points, and results; lookup and return scientific information; recall ingredients lists and recipes to solutions; assist in making solutions at specific concentrations; guide users through step-wise scientific protocols; perform calculations and “lab math”; provide task based reminders; store and provide access control to private data including custom solutions and protocols specific to a particular organization or lab; contact and communicate with other individuals via voice, video or text messaging; record notes while working in a protocol or recipe; record use of laboratory equipment and reagents; capture and create digital record of all laboratory and experiment activities; record the completion of an activity or an event; create a digital footprint of laboratory activities and events; and provide insights and analysis regarding laboratory inefficiencies and bottlenecks based at least on the digital footprint.

In further aspects, the platform can allow users to add their own custom information. For example, in the form of recipes, protocols, and calculations. The owner of any custom information can control access to the information by other users of the platform. For example, the owner can make the custom information public, thereby allowing any platform user to access the information via the platform; or private, thereby restricting access to custom information to the owner, or shared, thereby restricting access to the custom information to a defined group of platform users.

In further aspects, the platform can create a digital laboratory footprint and provide intelligence regarding the digital foot print and various lab activity and event records put into the platform. By way of non-limiting example, a platform user can, by means of verbal prompts, tell the platform they have completed step 2 of a protocol or reserve a piece of shared laboratory equipment for a specified time period. In addition to capturing events thru explicit prompts from users, the platform can capture implicit events. To this end, a user may ask the platform for step 3 of the protocol which can implicitly signal the system to record an event that step 2 of the protocol has been completed. These events can be collected by the platform to provide a digital footprint of all laboratory activities or all events during a single experimental run. In still further aspects, the digital footprint can be analyzed by the platform to provide derived intelligence or be made available for analysis outside the through a web interface. In yet further aspects, platform algorithms can be used to programmatically analyze the digital footprint to provide insights and analysis, for example laboratory inefficiencies and bottlenecks and to troubleshoot experimental procedures. In still further aspects, potential insights may include, but are not limited to, identification of an increase in demand for a particular piece of shared laboratory equipment, when and how much of a particular chemical or reagent to re-order, or identification a particular step in a protocol that deviates from a standard or known norm.

In various aspects, embodiments of the present disclosure may operate as a virtual laboratory assistant that uses artificial intelligence (AI) to “remember” and access information requested through natural language. In some aspects, the virtual laboratory assistant may comprise graphical and/or textual representations overlaid on a user's mobile device, on augmented reality (AR) devices, smart glasses such as Google Glass, or other nearby device. These representations may enable, for example, visual or textual information related to or corresponding to auditory responses.

In further aspects, embodiments may utilize artificial conversational entities or conversational agents (“CA”), for example, to add more responses for the user because of the algorithm it will use. In order to interact with certain embodiments of the present disclosure, users may first have to prompt its interface with speech so the conversational agents must have depth in its responses and questions.

In still further aspects, embodiments of the present disclosure may combine Augmented Reality (AR) with the use of an embodied conversational agent. Embodied conversational agents (“ECA”) may be a form of intelligent user interface. Graphically embodied agents may aim to unite gesture, facial expression and speech to enable face-to-face communication with users, providing a powerful means of human-computer interaction. Similar to Alexa from Amazon and Siri from the iOS platform of smartphones, an ECA may be embodied as basically Siri with a face. Combining ECAs and Artificial Realities (‘ARs’) may allow researchers to ask an Augmented Reality ECA any question and have the agent respond in a similar fashion as if talking to a human. In some embodiments, only a smartphone may be needed for each platform the application is on. A video and audio recording device may be utilized, along with a speaker to transmit what was said from embodiments of the present disclosure. Embodiments of the present disclosure may be able to interact with the user in real time, as if there were an actual person standing in front of the user.

In further aspects, embodiments of the present disclosure may be able to provide through the platform, reference data (ex. molecular weight, boiling points, melting points) and other information and much more, but also be able to guide them through multi-step protocols and preparation of recipes. For example, embodiments of the present disclosure may provide virtual laboratory agents to virtually talk and interact with the user, for example, to follow them through the steps of a laboratory protocol or recipe.

In various embodiments, a conversation user interface or voice-activated natural language user interface (UI) may be used for receiving and processing natural language spoken words and commands, converting speech to text and/or similarly converting text to speech, and playback. Based on a set of programmable rules, a speech recognition processor and/or natural language processor (NPL) can determine the intent of the spoken command from a known set of intents. The platform may then retrieve the requested information based on the intent of the command, for example, by interfacing with separate software programs and/or databases. The natural language processor may then convert the retrieved response from a digital format to a natural language auditory response. For example, Google voice API can translate what users say in their microphones into words and may use their voices as computer inputs.

In further aspects, the platform may make assumptions about a number of items such as a laboratory user's needs or a laboratory user's intent when generating a request or query. In still further aspects, the assumptions may include parameters or criteria used by speech recognition processors to parse the input data from the user, various language models and logic used by NLPs to interpret the user input data, and external factors such as user profiles, learned behavior, and context indicia. In laboratory related matters, one assumption may be that the user desires that outcome which is most likely to yield the best scientific results. In some aspects, the assumptions may involve use of clarifications so that appropriate assumptions may be derived. In further aspects, if the user speaks input data that is ambiguous, the conversation UI may provide one or more clarifications that seek to have the user clarify his or her intent.

In further aspects, determining a response to a particular command or request from the user may comprise using various techniques. The techniques may take into account a context associated with the command or request when determining the intent or meaning of the patient's command. In still further aspects, this context may be taken into account again when determining a response or reply to provide back to the user. In some aspects, the techniques take the same pieces of context into account when identifying the intent and the response. In other aspects, the techniques may take into account different pieces of context. To this end, the platform can provide responses that more closely emulate human-to-human conversation than when compared to traditional techniques for identifying virtual-assistant responses.

In further aspects, determining a response may comprise parsing the input data and using natural language processing to identify one or more concepts expressed therein. In still further aspects, the concepts may be based at least on keywords within the input data. In yet further aspects, these concepts may comprise keywords or key phrases, such as “calculate,” “chemical formula,” and the like in this example involving a laboratory. After identifying the concepts expressed in the input data, the platform may identify a context associated with the input. In further aspects, the context associated with the input data may include a context associated with the user, a context associated with the user's session on the platform, and the like. In some aspects, a context can be expressed as a value of one or more variables, such as whether or not a user has certification or has been trained to use certain lab equipment (e.g., “training completed=true” or “training completed=false”). In further aspects, the platform may make an assumption that the user wishes to complete a lab activity with lab equipment he or she is train to use unless there is an indication that he or she wishes to use a specialized device. A context associated with the input data may comprise a value associated with any type of variable that aids in understanding the meaning of a particular response provided by the patient.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### B. Platform Configuration

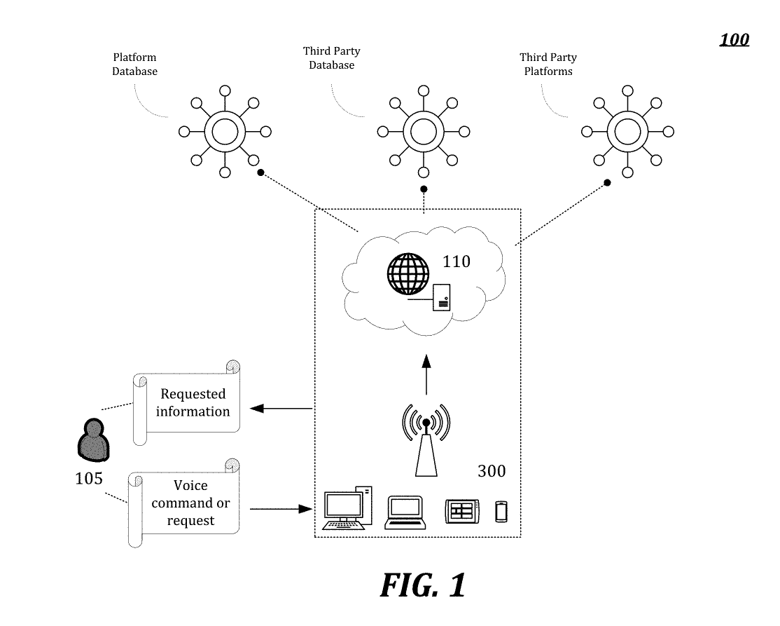

In various aspects, FIG. 1 illustrates one possible operating environment through which a platform consistent with embodiments of the present disclosure may be provided. By way of non-limiting example, a platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device. One possible embodiment of the application may be provided by a Helix product and service.

Platform 100 may also provide an online interface for enabling users to interact with the platform. Such an online interface may be configured to receive user and profile information. Further, the online interface may be configured to enable a user to search through his or her profile and data gathered or recorded through the platform.

Moreover, platform 100 may provide an application interface that may be accessed with devices such as, for example, a desktop, laptop, smartphone or tablet device. The various applications that are adapted to each of these devices may be configured to communicate with server 110 perform the same function as the aforementioned online interface. In embodiments where the device has location tracking technology, the application may provide the platform with location information using location detection methods associated with the device, such as, for example, GPS, Wi-Fi and cell tower triangulation.

In addition to the platform interfacing with users through stand-alone website or application, the present platform may interface with laboratory devices and third-party platforms through an app/plug-in/or software otherwise compatible with an Application Programming Interface (API). In this way, employing the API, the platform may retrieve user information (e.g., user settings, preferences, device permissions, activity records, and the like) from the third-party platform. Furthermore, the present platform may interface with other platforms through an administrator platform that may provide additional privileges to administrators.

The platform consistent with embodiments of the present disclosure may be configured to receive information from a plurality of databases. The databases may include, but not be limited to, for example, lab data (e.g., information about various scientific repositories, and the like), calendar data (e.g., information about various schedules associated with lab devices and users of the platform), lab reports and records (e.g., experimental data or data related completed lab routines or protocols), statistical lab activity data (e.g., historical lab data and records). The information received from these databases may be employed in providing options of scheduling, lab protocols, lab techniques and lab supply data to the various embodiments disclosed herein.

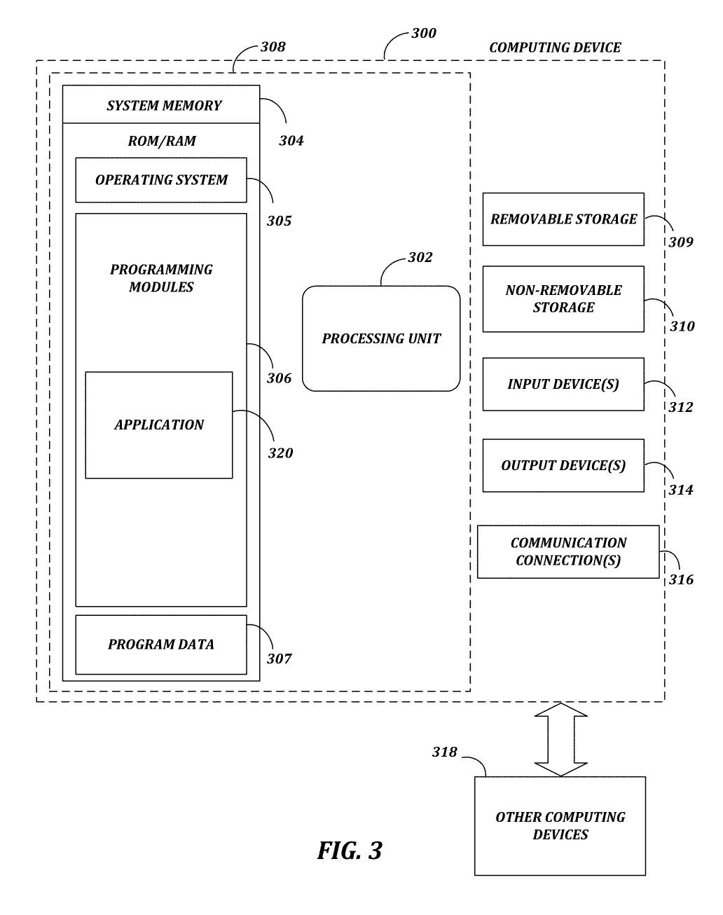

As will be detailed with reference to FIG. 3 below, the computing device through which the platform may be accessed may comprise, but not be limited to, for example, a desktop computer, laptop, a tablet, AR device, smart speaker, smart glasses, or mobile telecommunications device. In yet further embodiments, the computing device may comprise a smart-watch or smart-glasses adapted for mobile computing. Though the present disclosure is written with reference to a smart speaker or mobile telecommunications device, it should be understood that any computing device may be employed to provide the various embodiments disclosed herein.

### C. Platform Operation

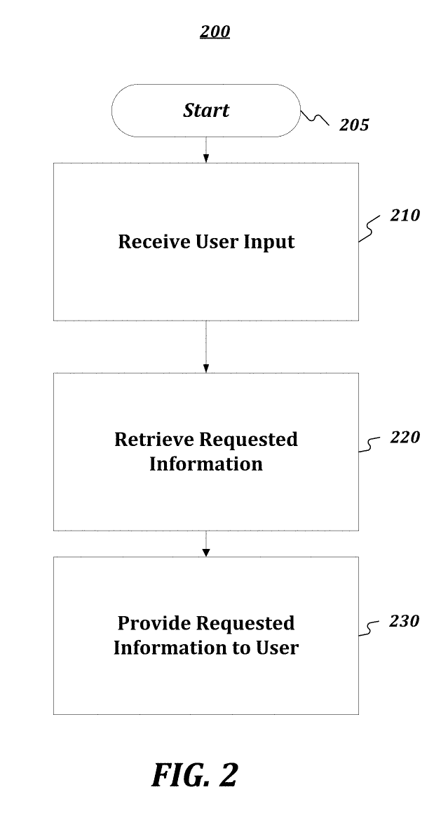

In various aspects, FIG. 2 is a flow chart setting forth the general stages involved in a method 200 consistent with an embodiment of the disclosure for providing platform 100. Method 200 may be implemented using a computing device 300 as described in more detail below with respect to FIG. 3.

Although method 200 has been described to be performed by platform 100, it should be understood that computing device 300 may be used to perform the various stages of method 200. Furthermore, in some embodiments, different operations may be performed by different networked elements in operative communication with computing device 300. For example, server 110 may be employed in the performance of some or all of the stages in method 200. Moreover, server 110 may be configured much like computing device 300.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of the disclosed methods will be described in greater detail below.

Method 200 may begin at starting block 205 and proceed to stage 210 where platform 100 may receive information and/or input data from a user. In further aspects, platform 100 may receive user input, for example, via voice command. Further, a user may create and register a profile. The profile may contain user information and/or laboratory data such as, for example, information related to location, user group, organization, school, name, lab activities of interest, calendar data, scheduling data, event data, image data, video data, audio data, and the like. The profile may further contain information, such as, for example, predetermined selection criteria or preferences that can be used by the system to determine potential devious from expected results or outcomes, such for a given experiment.

In still further aspects, the inputs may be put into a smart speaker or computing device (e.g., a user's cell phone) using, for example, voice to text integration. In further aspects, voice-activated natural language user interface or conversational agent may be used. Voice to text input integrated with the user interface or conversational agent may send the text it receives from the user to a database, for example, using SMS (short message service) to PHP (hypertext preprocessor) system database communication, or the like. In other aspects, a natural language processor may be used to determine the intent of the voice command from a known set of intents.

From stage 210, where platform 100 receives a user input, method 200 may advance to stage 220 where platform 100 may process data, such as, based on predetermined criteria, selection criteria or parameters, matching rules, and the like. In further aspects, platform 100 may provide, generate or retrieve information based on the processed data.

In some embodiments, a software program or application may be utilized to access a database, for example, to retrieve the requested information based on the intent of a command. By way of example, the software may expose a set of API endpoints that accepts a JSON formatted payload from the natural language processor that specifies the user's intent. Using custom logic and routines, the software can then fulfill the request by accessing the database on the system's local data storage. The database may respond with a different text that may be used as a rejoinder. The database may also answer the text it receives with cues for the response. In various aspects, the more developed the database, the faster the response may be. The database may be stored in the cloud or stored on a local storage device, or a combination thereof. In further aspects, the database may be used for storing recipes, inventories, formulas, protocols, and other types of scientific information/data as described herein. If the request or command cannot be fulfilled from the database, for example, stored on a local storage device, a secondary request may be made to third party web services. If the request to third party web services provides the necessary result, the platform may add the result to the database to fulfill future requests. All responses and retrieved information may be collected and stored as data. In other embodiments, information may be populated from data received from a third-party platform. For example, as mentioned above, the platform of the present disclosure may be configured to interface with a third-party platform over an API. Employing the API, the platform may retrieve and exchange user-data and records with the third-party platform.

From stage 220, where platform 100 processes data, method 200 may advance to stage 230 where platform 100 may provide information to the user, such as in response to requested information from the user. In some aspects, upon providing the platform with an indication that one user would like to begin a lab activity, the platform may provide the user with a listing of lab activities that may be relevant to that user. The listing of lab activities may be an up-to-date listing of certain lab events, activities, or statuses that may be of interest to the user.

In further aspects, the platform may access the local storage devices following voice commands and relay the requested information back to the user through the voice-activated device. Thus, in some aspects, the response may not require a network connection or take cellular data usage. As a further example, an embodied conversational agent may walk in the physical space of the user using augmented reality. The agent may then be able to provide visual presentation of data and instruction in addition to the auditory response provided by the voice-activated natural language user interface.

In various embodiments, the disclosed methods can include additional features and aspects. To this end, the user can access their smart speaker or mobile computing device, e.g., a mobile phone and activate the platform application installed thereon. The platform may work in conjunction with Alexa as a “skill” or add-on functionality. To this end and by way of non-limiting example, the user can press the activation button and/or say the activation phrase “Alexa, open HELIX” to activate and access the platform. Since the platform may use private data and/or confidential information; the user may be prompted to do a validation check. In this case, the user may provide a password or other form of authentication. In further aspects, the platform may work in conjunction with additional voice-enabled products such as SIRI, Google Assistant, and the like. The user may then be prompted to make a request, in which the user could respond with a command or say “settings” to edit the settings for the platform or language used by the platform.

In other aspects, the user can issue commands by saying “Alexa, ask HELIX” followed by the command. Non-limiting examples of commands can include: “What's the molecular weight of Potassium Acetate?”; “What's the recipe for 50X TAE?”; “Help me make a Coomassie Destain Solution.”; “Guide me through the protocol for E. coli competent cell preparation.”; “Where in my lab is Potassium Acetate?”; “When will I need more Sodium Chloride?”; “How many grams of Sodium Chloride do I need to make 10 ml of a 3M Sodium Chloride solution?”; “Make a note that I saw a white precipitate during step 3 of the protocol.”; “What's been recently published in Lyme disease research?”; “Page lab partner James.”; “I used 2 ml of Sodium Chloride”; “I completed step 3 of the protocol”; “Add 100 ml of Sodium Chloride to stock”; and “Checkout the thermocycler”.

After successful retrieval of the requested information, the platform may apply subroutines to format the information into a natural language string in digital format. The natural language string may be packaged, for example, as part of a JSON formatted payload, and sent to the voice-activated user interface for playback. If the request or command is invalid or cannot be fulfilled after searching third party databases, the platform may prompt the user to repeat the request or the like.

In various embodiments, the platform may comprise an interface, (i.e.—web interface, or application interface, etc.) configured to allow users to customize and/or add custom and/or proprietary data to the database, for example, in the form of recipes, protocols, inventories, etc. To this end, this feature can allow users real-time access to the custom content when a request is made for the information, while allowing access control to their custom content. In various aspects, the database can be stored on a local storage device, in the cloud, or a combination thereof. In further aspects, platform 100 may provide a platform for interaction between users and laboratory devices.

### D. Platform Architecture

In various aspects, the platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. It should be understood that, in some embodiments, different operations may be performed by different networked elements in operative communication with computing device 300.

Embodiments of the present disclosure may comprise a system having a memory storage and a processing unit. The processing unit coupled to the memory storage, wherein the processing unit is configured to perform the stages of the disclosed methods.

In various aspects, method 200 may be implemented using, at least in part, a computing device 300, such as controller (e.g., on-board computing device) as described in more detail below with respect to FIG. 3. Computing device 300 may comprise an integrated controller for performing the various stages of the disclosed method 200 and operational tasks, including, but not limited to, user matching and parameters, and communication. Furthermore, in some embodiments, different operations may be performed by different networked elements in operative communication with computing device 300. Furthermore, although stages are disclosed with reference to computing device 300, it should be understood that a plurality of other components may enable the operation of the disclosed methods, including, but not limited to, other computing components, mechanical components, environment properties (e.g., temperature), user conditions, and the like.

Moreover, the computing device, such as controller 300, may be in operative communication with a centralized server, such as, for example, a cloud computing service. Although operation has been described to be performed, in part, by a computing device 300, it should be understood that, in some embodiments, different operations may be performed by different networked elements in operative communication with computing device 300. In further aspects, embodiments of the present disclosure may comprise a system having a memory storage and a processing unit. The processing unit may be coupled to the memory storage, wherein the processing unit is configured to perform the stages of method 200.

FIG. 3 is a block diagram of a system including a computing device 300. Consistent with an embodiment of the disclosure, the aforementioned memory storage and processing unit may be implemented in a computing device 300, such as controller. Any suitable combination of hardware, software, or firmware may be used to implement the memory storage and processing unit. For example, the memory storage and processing unit may be implemented with computing device 300 or any of other computing device 318, in combination with computing device 300. The aforementioned system, device, and processors are examples and other systems, devices, and processors may comprise the aforementioned memory storage and processing unit, consistent with embodiments of the disclosure.

With reference to FIG. 3, a system consistent with an embodiment of the disclosure may include a computing device 300, such as a controller. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling controller 300's operation. In one embodiment, programming modules 306 may include controller application (“app”) 320, and user-matching modules, communication modules and interface modules. Furthermore, embodiments of the disclosure may be practiced in conjunction with a graphics library, other operating systems, or any other application program and is not limited to any particular application or system. This basic configuration is illustrated in FIG. 3 by those components within a dashed line 308.

Advantageously, the app may provide a user with information as well as be the user's interface to operating the embodiment of the invention. The app may include one or more graphic user interfaces (GUIs). Among the GUIs of the app may be a GUI allowing the user to pick which, if there is more than one, activities and/or events to participate in, and to select (if available) one or more operating parameters or characteristics (such as location, group, organization, club, school, name, age, gender, at least one activity of interest, activity skill, activity frequency, etc.) of the platform. The user may be able to adjust such selections from a GUI of the app.

The GUI may include additional or other information relating to the platform such as a map data with displayed users represented on the map using a symbol, character, image, or the like. The app may also present the user with information received from the platform or other users, such as messages and notifications.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also be operative with input device(s) 312 such as a keyboard, a mouse, a pen, a sound input device, a touch input device, etc. Input device(s) 312 may be used to, for example, manually access and program computing device 300. Output device(s) 314 such as a display, speakers, a printer, etc. may also be included. The aforementioned devices are examples and others may be used.

Computing device 300 may also contain a communication connection 316 that may allow a device with a controller, such as computing device 300 to communicate with other computing and wireless devices 318, such as over an encrypted network in a distributed computing environment. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, Bluetooth, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g., virtual lab assistant application 320) may perform processes including, for example, one or more of stages or portions of stages of the disclosed methods as described above. The aforementioned process is an example, and processing unit 302 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The present disclosure includes at least the following aspects: Aspect 1: A method of providing virtual assistance to a user for performing an activity, the method comprising: enabling, by a system having at least one processor, a conversation user interface associated with a conversational agent configured as a virtual assistant; receiving, by the system, input data from a laboratory user associated with a laboratory user group, the input data comprising at least one of verbal data, voice data and textual data; determining, by the system, an intent of the laboratory user based at least on the input data and a first context; determining, by the system, a response to the input data based at least in part on laboratory record data associated with the laboratory user group and a second context that is different than the first context; and providing, by the system, the response through the conversation user interface as a message from the virtual assistant.

Aspect 2: The method of any preceding aspect, wherein the input data is verbal data, and the verbal data is converted in the conversation user interface to a text format through a speech recognition component.

Aspect 3: The method of any preceding aspect, wherein the input is verbal data, and determining a response comprises interpreting the verbal data through speech recognition and ascertaining a suitable response for the verbal data through natural language processing.

Aspect 4: The method of any preceding aspect, wherein determining the response is based at least in part on first assumptions pertaining to speech recognition of the verbal data and second assumptions pertaining to natural language processing of the verbal input.

Aspect 5: The method of any preceding aspect, further comprising representing, by the system, the first and second assumptions in association with the response in the conversation user interface.

Aspect 6: The method of any preceding aspect, wherein the input is verbal input; and wherein the method further comprises authenticating, by the system, an identity of the user through analysis of voice patterns contained in the verbal data.

Aspect 7: The method of any preceding aspect, wherein at least one of the first context and the second context comprises past behavior of the user.

Aspect 8: The method of any preceding aspect, wherein at least one of the first context and the second context comprises a status of the user related to the user group.

Aspect 9: The method of any preceding aspect, wherein at least one of the first context and the second context comprises a status of clocked-in or clocked-out of a laboratory user group.

Aspect 10: The method of any preceding aspect, further comprising receiving, by the system, a request from the user to expose assumptions used in determining the response; and exposing the assumptions through the conversation user interface.

Aspect 11: The method of any preceding aspect, wherein determining a response to the input is based at least on one of scientific research results, historical laboratory user group record information, and laboratory protocol information.

Aspect 12: The method of any preceding aspect, further comprising parsing, by the system, the input data to identify at least one concept contained within the received input data; wherein the intent is determined based at least on the at least one concept.

Aspect 13: The method of any preceding aspect, wherein identifying the at least one concept comprises identifying at least one keyword within the input data and mapping the at least one keyword with the at least one concept.

Aspect 14: The method of any preceding aspect, wherein determining the intent comprises mapping at least one concept to one of multiple different intents associated with the at least one concept based at least on at least one of the first context and the second context.

Aspect 15: The method of any preceding aspect, further comprising mapping, by the system, the intent to one of multiple different responses associated with the intent based at least on at least one of the first context and the second context.

Aspect 16: The method of any preceding aspect, wherein at least one of the first context or the second context comprises: a status of a laboratory device used by the user; a level of at least one lab supply available to the user; a time of day at which the user provides the request to the virtual assistant; a date on which the user provides the request to the virtual assistant; a location of the user; or a device type from which the user accesses the content.

Aspect 17: The method of any preceding aspect, further comprising causing, by the system, an action on behalf of the user, the action comprising at least one of: scheduling an appointment on behalf of the user; initiating a request on behalf of the user; accessing data from a laboratory device on behalf of the user; communicating with another user on behalf of the user; and altering a previously initiated action on behalf of the user.

Aspect 18: The method of any preceding aspect, further comprise learning, by the system, that certain words of the input data are associated with certain vocabulary terms.

Aspect 19: The method of any preceding aspect, further comprising learning that certain phrases of the input data are associated with corresponding concepts.

Aspect 20: The method of any preceding aspect, further comprising in response to receiving the input data: forwarding, by the system, the input data to a third-party; and providing, by the system, a response received from the third-party through the conversation user interface.

Aspect 21: The method of any preceding aspect, wherein forwarding the input data comprises at least one of: ordering at least one laboratory supply; recording experimental data in the laboratory records; and retrieving scientific information.

Aspect 22: A method comprising: enabling, by a system having at least one processor, a conversation user interface associated with a conversational agent configured as a virtual assistant; receiving, by the system, speech input from a user associated with a user group, the user having a user profile; processing, by the system, the speech input; determining, by the system, based on the processed speech input that the user requests a technique to perform a laboratory experiment; determining, by the system, a laboratory protocol having one or more steps for the user based at least on the laboratory experiment; and providing, by the system, directions from the virtual assistant to the user for performing the laboratory protocol.

Aspect 23: The method of any preceding aspect, wherein the speech input includes a request for a recommendation of a laboratory protocol.

Aspect 24: The method of any preceding aspect, wherein the speech input includes at least one of: type of experimental result, a supply used in the experiment, at least one chemical reagent used in the experiment, and at least one laboratory device used in the experiment.

Aspect 25: The method of any preceding aspect, wherein the recommended laboratory protocol comprises a laboratory protocol designed to improve at least one of reliability of experimental results, time to complete experiment, efficiency of performing the experiment, ease of performing the experiment, availability of laboratory devices for performing the experiment; and availability of supplies for performing the experiment.

Aspect 26: The method of any preceding aspect, further comprise selecting the laboratory protocol based at least on one of the user profile and historical laboratory records associated with the user.

Aspect 27: The method of any preceding aspect, further comprise selecting the laboratory protocol based at least on one of the user group profile and historical laboratory records associated with the user group.

Aspect 28: The method of any preceding aspect, further comprise providing a response [from the virtual assistant] through the conversation user interface when the user completes at least one step associated with the laboratory protocol.

Aspect 29: The method of any preceding aspect, further comprising notifying, by the system, the user through the virtual assistant when a completed step deviates from an expected outcome or result.

Aspect 30: The method of any preceding aspect, further comprising audibly outputting the directions for completing the steps using the virtual assistant.

Aspect 31: A method comprising: enabling, by a system having at least one processor, a conversation user interface associated with a conversational agent configured as a virtual assistant; receiving, by the system, user input through the conversation user interface, the user input comprising a query from the user about a scientific question; and providing, by the system, a response to the query using the virtual assistant, the response comprising comparative information about factors related to the scientific question for default parameters or typical conditions.

Aspect 32: The method of any preceding aspect, wherein the user input is verbal data, and the verbal data is represented in the conversation user interface in a text format through speech recognition techniques.

Aspect 33: The method of any preceding aspect, wherein the responses from the virtual assistant are rendered as audio output through the conversation user interface.

Aspect 34: The method of any preceding aspect, wherein the scientific question comprises a scientific question related to a lab activity being performed by the user.

Aspect 35: The method of any preceding aspect, wherein the comparative information presents a comparison between a metric based on conditions of the user with the metric for the typical conditions.

Aspect 36: The method of any preceding aspect, wherein the comparative information presents a comparison between a metric based on parameters of the user with the metric for the default parameters.

Aspect 35: The method of any preceding aspect, wherein the metric of the user is based at least on one of: historical laboratory records of the user, historical laboratory records of the user group; input provided by the user, a result of a test administered by the user, a result of an experiment performed by the user, or data from a laboratory device used by the user.

Aspect 36: The method of any preceding aspect, wherein laboratory record data comprises information related to completed laboratory experiments and protocols.

Aspect 37: A system comprising a memory storage and a processing unit coupled to the memory storage, wherein the processing unit is operative to perform the method of any preceding aspect.

Aspect 38: A computer-readable medium comprising a set of instructions which, when executed, perform a method of any preceding aspect.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method of providing virtual assistance to a user for performing an activity, the method comprising
enabling, by a system having at least one processor, a conversation user interface associated with a conversational agent configured as a virtual assistant;
receiving, by the system, input data from a laboratory user associated with a laboratory user group, the input data comprising at least one of verbal data, voice data and textual data;
determining, by the system, an intent of the laboratory user based at least on the input data and a first context;
determining, by the system, a response to the input data based at least in part on laboratory record data associated with the laboratory user group and a second context that is different than the first context; and
providing, by the system, the response through the conversation user interface as a message from the virtual assistant.

2. The method of claim 1, wherein the input data is verbal data, and the verbal data is converted in the conversation user interface to a text format through a speech recognition component or

3. The method of claim 1, wherein the input is verbal data, and determining a response comprises interpreting the verbal data through speech recognition and ascertaining a suitable response for the verbal data through natural language processing.

4. The method of claim 3, wherein determining the response is based at least in part on first assumptions pertaining to speech recognition of the verbal data and second assumptions pertaining to natural language processing of the verbal input.

5. The method of claim 4, further comprising representing, by the system, the first and second assumptions in association with the response in the conversation user interface.

6. The method of claim 5, wherein the input is verbal input; and wherein the method further comprises authenticating, by the system, an identity of the user through analysis of voice patterns contained in the verbal data.

7. The method of claim 6, wherein determining a response to the input is based at least on one of scientific research results, historical laboratory user group record information, and laboratory protocol information.

8. The method of claim 7, further comprising parsing, by the system, the input data to identify at least one concept contained within the received input data; wherein the intent is determined based at least on the at least one concept.

9. The method of claim 8, further comprising causing, by the system, an action on behalf of the user, the action comprising at least one of:
scheduling an appointment on behalf of the user;
initiating a request on behalf of the user;
accessing data from a laboratory device on behalf of the user;
communicating with another user on behalf of the user; and
altering a previously initiated action on behalf of the user.

10. The method of claim 9, further comprising in response to receiving the input data: forwarding, by the system, the input data to a third-party; and providing, by the system, a response received from the third-party through the conversation user interface.

11. A method comprising:
enabling, by a system having at least one processor, a conversation user interface associated with a conversational agent configured as a virtual assistant;
receiving, by the system, speech input from a user associated with a user group, the user having a user profile;
processing, by the system, the speech input;
determining, by the system, based on the processed speech input that the user requests a technique to perform a laboratory experiment;
determining, by the system, a laboratory protocol having one or more steps for the user based at least on the laboratory experiment; and
providing, by the system, directions from the virtual assistant to the user for performing the laboratory protocol.

12. The method of claim 11, wherein the speech input includes a request for a recommendation of a predefined laboratory protocol.

13. The method of claim 12, wherein the speech input includes at least one of: type of experimental result, a supply used in the experiment, at least one chemical reagent used in the experiment, and at least one laboratory device used in the experiment.

14. The method of claim 13, wherein the recommended laboratory protocol comprises a laboratory protocol designed to improve at least one of reliability of experimental results, time to complete experiment, efficiency of performing the experiment, ease of performing the experiment, availability of laboratory devices for performing the experiment; and availability of supplies for performing the experiment.

15. The method of claim 14, further comprise selecting the laboratory protocol based at least on one of the user profile and historical laboratory records associated with the user, and the user group profile and historical laboratory records associated with the user group.

16. The method of claim 15, further comprise providing a response through the conversation user interface when the user completes at least one step associated with the laboratory protocol or when a completed step deviates from an expected outcome or result.

17. The method of claim 16, further comprising audibly outputting the directions for completing the steps using the virtual assistant.

18. A method comprising:
enabling, by a system having at least one processor, a conversation user interface associated with a conversational agent configured as a virtual assistant;
receiving, by the system, user input through the conversation user interface, the user input comprising a query from the user about a scientific question; and
providing, by the system, a response to the query using the virtual assistant, the response comprising comparative information about factors related to the scientific question for default parameters or typical conditions.
The method of claim, wherein the user input is verbal data, and the verbal data is represented in the conversation user interface in a text format through speech recognition techniques.
The method of claim, wherein the responses from the virtual assistant are rendered as audio output through the conversation user interface.

19. The method of claim 18, wherein the scientific question comprises a scientific question related to a lab activity being performed by the user; and wherein the comparative information presents at least one of: a comparison between a metric based on conditions of the user with the metric for the typical conditions; and a comparison between a metric based on parameters of the user with the metric for the default parameters.

20. The method of claim 19, wherein the metric of the user is based at least on one of: historical laboratory records of the user, historical laboratory records of the user group; input provided by the user, a result of a test administered by the user, a result of an experiment performed by the user, or data from a laboratory device used by the user.
